(19) United States
(12) Patent Application Publication
(10) Pub. No.: US 2009/0003966 A1
(43) Pub. Date: Jan. 1, 2009

(54) Structure of screw nail

(76) Inventor: Kuo-Tai Hsu, Yong Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,170

(22) Filed: Jun. 26, 2007

(51) Int. Cl. F16B 15/06

(52) U.S. Cl. 411/394

(57) ABSTRACT

Disclosed is a screw nail, which has chip grooves respectively obliquely cut through top and bottom sides of each of the threads thereof at different elevations and defining with each thread two parallel cutting edges, and a plurality of guide ribs protruded from the periphery of the nail shank and respectively connected between each two vertically spaced adjacent chip grooves for guiding out cut chips and enhancing binding between the screw nail and the workpiece.

### BACKGROUND OF THE INVENTION

1. Field of the Invention

The present invention relates to screw nails and more particularly, to an improved structure of screw nail with small torsion and high binding force. The screw nail has chip grooves obliquely cut through the threads and guide ribs respectively connected between each two vertically spaced adjacent chip grooves to reduce torsion and to guide away cut chips.

2. Description of the Related Art

In an article, screw nails are small devices to join parts and to fix parts in place. Although these screw nails are small, they are important. Different screw nails may be used for different purposes to fasten different materials. For example, screw nails for fastening wooden materials are different from that for fastening metal materials. Because wooden materials are soft, the thread pitch must be relatively greater so that wooden materials can have a relatively greater bearing thickness to bear the tightening stress. Because metal materials are hard, the thread pitch can be relatively smaller, and metal materials require a relatively smaller bearing thickness to bear the tightening stress. Therefore, many different types of screw nails are available on the market.

U.S. Pat. No. 5,895,187 discloses a nail entitled “Pilot Nail”, which has small torsion, excellent leading and excellent balance. This design of pilot nail has secondary threads and auxiliary threads to reduce the torsion of the pilot screw. However, because the secondary threads and auxiliary threads have a height smaller than the spiral thread, the chip removal function is weak.

Therefore, it is desirable to provide a screw nail that eliminates the aforesaid drawback.

### SUMMARY OF THE INVENTION

The present invention has been accomplished under the circumstances in view. It is one object of the present invention to provide an improvement structure of screw nail, which can quickly be driven into the workpiece quickly with less effort. It is another object of the present invention to provide an improved structure of screw nail, which has means to expel cut chips and means to enhance binding between the screw nail and the workpiece.

To achieve these and other objects of the present invention, the screw nail comprises a head, a point, a shank connected between the head and the point, and threads spirally extending around the shank at different elevations between the point and the shank. The improvement comprises a plurality of chip grooves respectively obliquely cut through top and bottom sides of each of the threads at different elevations and defining with each thread two parallel cutting edges, and a plurality of guide ribs protruded from the periphery of the shank and respectively connected between each two vertically spaced adjacent chip grooves for guiding out cut chips and enhancing binding between the screw nail and the workpiece.

Further, the chip grooves can be made having a depth shorter than or equal to the height of the guide ribs.

### BRIEF DESCRIPTION OF THE DRAWINGS

FIG. 1 is a schematic drawing showing the structure of a screw nail according to the present invention.

FIG. 2 is an enlarged view of a part of the screw nail shown in FIG. 1.

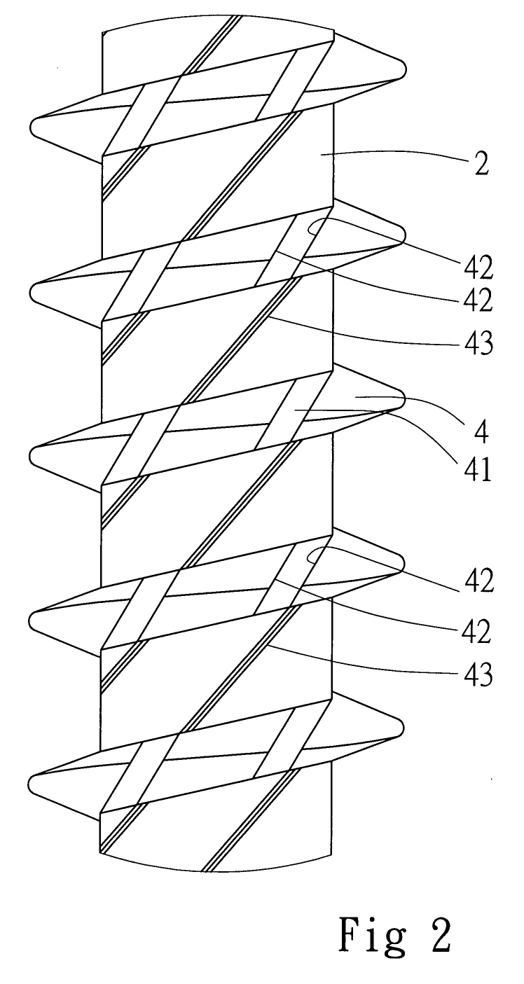

FIG. 3 is a schematic sectional view in an enlarged scale of the shank of the screw nail shown in FIG. 1.

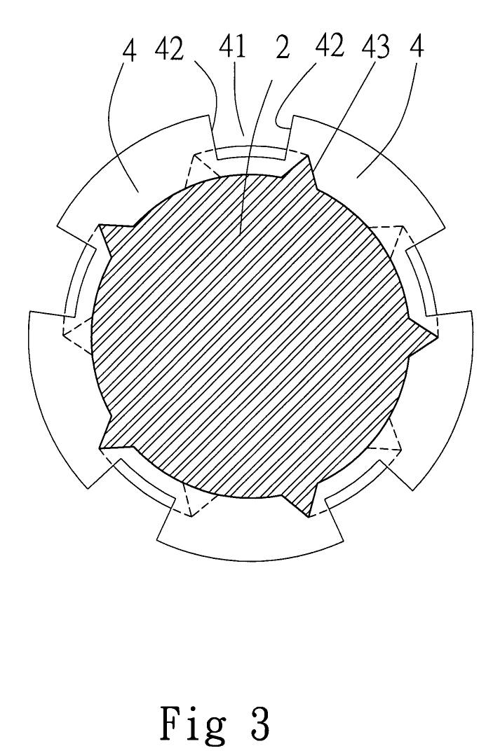

FIG. 4 is a schematic drawing showing an installation action of the screw nail according to the present invention.

FIG. 5 is a schematic drawing showing another installation action of the screw nail according to the present invention.

FIG. 6 is a schematic drawing showing an alternate form of the screw nail according to the present invention.

### DETAILED DESCRIPTION OF THE PREFERRED EMBODIMENT

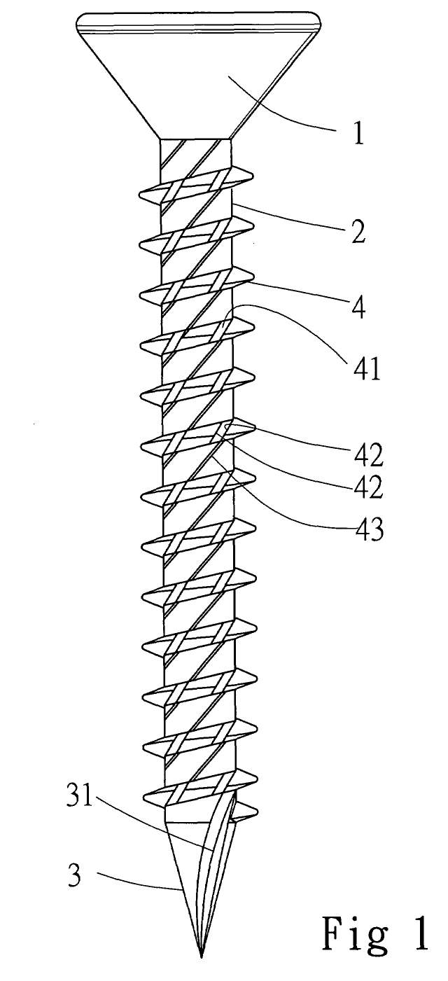

Referring to FIGS. 1˜3, a screw nail in accordance with the present invention is shown comprising a head 1, a point 3, a shank 2 connected between the head 1 and the point 3, threads 4 spirally extending around the periphery of the shank 2 from the point 3 to the head 1, and V-shaped cut grooves 31 on the point 3.

The screw nail further comprises a plurality of chip grooves 41 respectively cut through top and bottom sides of the threads 4. Each chip groove 41 has two parallel sidewalls respectively defined with the associating thread 4 a respective auxiliary cutting edge 42. The screw nail further comprises a plurality of guide ribs 43 protruded from the periphery and respectively connected between each two vertically spaced chip grooves 41.

The depth of the chip grooves 41 can be shorter than the height of the guide ribs 43. Alternatively, the depth of the chip grooves 41 can be equal to the height of the guide ribs 43.

The aforesaid cut grooves 41 respectively obliquely cut through the top and bottom sides of each of the threads 41. The guide ribs 43 are respectively obliquely connected between each two vertically spaced chip grooves 41 at one side for guiding cut chips through the chip grooves 41 when the screw nail is driven into a workpiece.

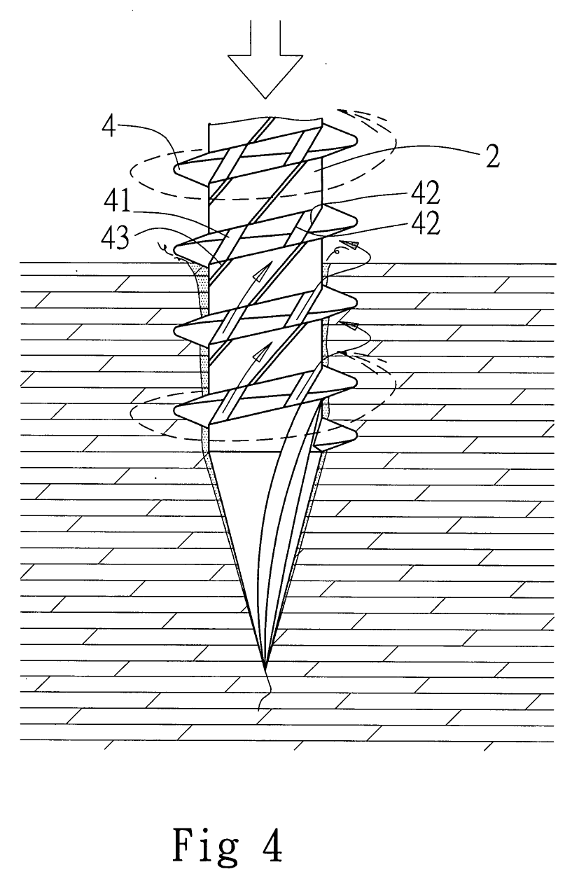

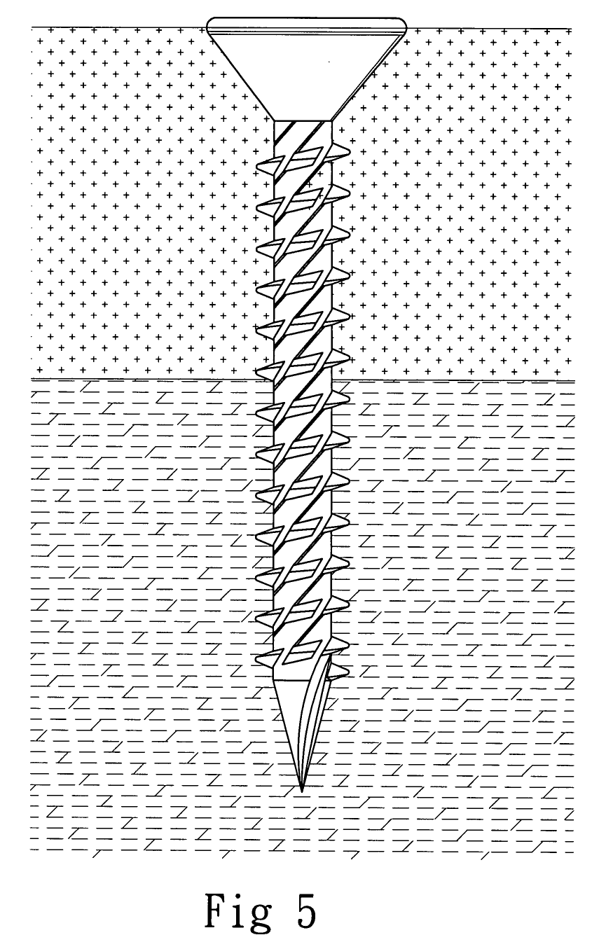

When driving the screw nail into the workpiece, as shown in FIGS. 4 and 5, the point 3 and the V-shaped cut grooves 31 are rotated to drill a hole on the workpiece. At this time, the guide ribs 43 at the connection area between the point 3 and the shank 2 work to expand the hole drilled by the point 3 and the V-shaped cut grooves 31. Matching with the drill hole expanding functioning of the guide ribs 43 at the connection area between the point 3 and the shank 2, the threads 4, the guide ribs 43 and the auxiliary cutting edges 42 form a high power milling structure to cut through the workpiece vertically in an even manner at a high speed without much resistance. During cutting action, each guide rib 43 between two vertically spaced chip grooves 41 guides the cut chips upwardly through every chip groove 41 to the outside, preventing accumulation of cut chips in the workpiece to produce resistance to the cutting action of the screw nail. Therefore, the user can drive the screw nail into the workpiece with less effort. Once the screw nail is fully driven into the workpiece, the guide ribs 43 provide an engagement effect to enhance binding between the screw nail and the workpiece.

As indicated above, the screw nail design uses the threads 4 and the auxiliary cutting edges 42 to mill the workpiece, and the guide ribs 43 to expand the drilled hole, to expel cut chips, and to enhance binding between the screw nail and the workpiece. Further, the guide ribs 43 guide cut chips upwards through the chip grooves 41 toward the outside, enabling the screw nail to be driven into the workpiece, quickly with less effort.

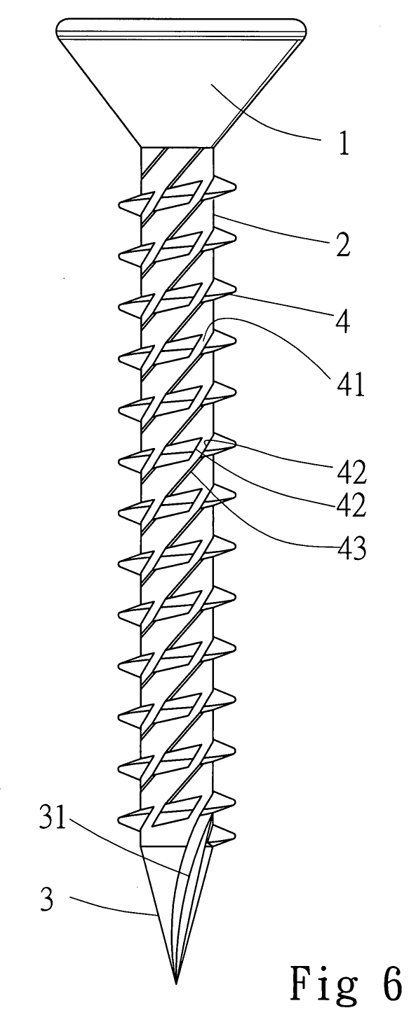

In the aforesaid embodiment, the chip grooves 41 are disposed in flush with the surface of the shank 2. In an alternate form of the present invention as shown in FIG. 6, the chip grooves 41 directly cut into the periphery of the shank 2.

Although a particular embodiment of the invention has been described in detail for purposes of illustration, various modifications and enhancements may be made without departing from the spirit and scope of the invention. Accordingly, the invention is not to be limited except as by the appended claims

What the invention claimed is:

1. A screw nail comprising a head, a point, a shank connected between said head and said point, and a plurality of threads spirally extending around said shank at different elevations between said point and said head, the improvement comprising a plurality of chip grooves respectively cut through top and bottom sides of said threads at different elevations and a plurality of guide ribs protruded from the periphery of said shank and respectively connected between each two vertically spaced adjacent chip grooves.

2. The screw nail as claimed in claim 1, wherein said chip grooves are obliquely disposed at the periphery of said shanks at different elevations, each having two parallel sidewalls.

3. The screw nail as claimed in claim 1, wherein said guide ribs are respectively connected between each two vertically spaced adjacent chip grooves at one side.

4. The screw nail as claimed in claim 1, wherein said chip grooves have a depth shorter than the height of said guide ribs.

5. The screw nail as claimed in claim 1, wherein said chip grooves have a depth equal to the height of said guide ribs.

6. The screw nail as claimed in claim 1, wherein the two parallel sidewalls of each of said chip grooves define with the associating thread a respective auxiliary cutting edge.

7. The screw nail as claimed in claim 1, further comprising at least one V-shaped cut groove formed on said point and extending to said shank.
